(19) United States
(12) Patent Application Publication
(10) Pub. No.: US 2012/0036079 A1
(43) Pub. Date: Feb. 9, 2012

(54) BUILDING SOCIAL NETWORKS BASED ON COMMERCE

(75) Inventors: GEORGE T. JACOB SUSHIL, Bangalore (IN); KALAPRIYA KANNAN, Bangalore (IN)

(73) Assignee: INTERNATIONAL BUSINESS MACHINES CORPORATION, Armonk, NY (US)

(21) Appl. No.: 12/851,936

(22) Filed: Aug. 6, 2010

(51) Int. Cl. G06Q 30/00; G06Q 99/00; G06F 15/16

(52) U.S. Cl. 705/319; 709/204

(57) ABSTRACT

A social network relating consumers to a commerce system of interest is built. Weights are assigned for individual nodes of the social network based on predetermined criteria. The social network is navigated to identify customer leaders and define customer segments of the commerce system. The social network is also navigated to identify specific communication channels relative to the customer leaders. Effective marketing strategies are defined using the customer leaders and the specific communication channels.

### BACKGROUND

The present invention relates in general to marketing strategies, and more particularly, to improving targeted marketing.

Merchants want to sell their products to loyal customers and expand their sales by acquiring new customers. One way to improve sales is to use marketing to target current customers that are most likely to be interested in the merchant's products. Often, a current customer is an excellent resource for obtaining new customers. Current customers can help increase sales by sharing positive information about the buying experience, the product and the merchant.

With the increasing popularity of on-line commerce and on-line social networks, there is a great deal of available information about people and their interests. It is more common than ever for buyers to use the Internet for at least part of their purchases. They may go on-line to compare similar products from different venders, to compare prices, to obtain product information, and so on. Once a decision is reached, many users complete their transaction over the Internet, as well. Once the product is received and tested, there is often information sharing through on-line social networks. It could be extremely valuable for a merchant to be able to employ the social networking to improve sales.

Popularity of social networks through the Internet has become a viable media for increasing the social presence of people. It is important to realize that only information that is approved for use by the owner of the information is used. This increased presence has opened new channels or media for marketing, and the online presence of people and their activities can be utilized for marketing, when the people authorize such use. Social presence through various activities, such as, online conversation and opinion sharing, may have significant impact on people in a group or community. It has been observed that these people, as consumers, often adapt their product purchasing decisions based on collective opinion from a social network. Product manufacturers or businesses can leverage this network of people to promote their brand and improve the brand awareness among people.

Marketing strategy based on social networks may become ineffective if the individuals chosen as ambassadors for the brand or product are not respected within the social network. Less respected people can make the marketing strategies ineffective, and, consequently, the business may bring negative value to the brand. The importance of social media increases manifold when well respected individuals play a key role in improving the conversion rate of a product. Therefore, it is important to identify these ambassadors and follow them to promote the products. However, the method of identifying such people in the social network is not a trivial task. There are several factors that limit the identification of well respected people and how to utilize them for marketing strategies. First, identification of these individuals in the network is limited by the data that are representative of the individual's impact on others. It requires defining and analyzing the social activities that can provide insight into an individual's social impact. Second, a lack of programs for these ambassadors can hamper the marketing strategies and render them ineffective. Therefore, a well formulated program has to be devised such that the online stores can utilize them in a manner that increases the awareness or transaction of their brands or products.

The concept of utilizing ambassadors can be further extended to commerce patterns, such as, popularity of coupons, can be relied upon to bring revenue to the stores.

### BRIEF SUMMARY

According to one embodiment of the present invention, a method defines marketing strategies by identifying social commerce patterns. A social network relating consumers to a commerce system of interest is built. Weights are assigned for individual nodes of the social network based on predetermined criteria. The weights and the criteria are stored in a memory. The social network is navigated to identify customer leaders and define customer segments of the commerce system. The social network is also navigated to identify specific communication channels relative to the customer leaders. Marketing strategies are then defined using the customer leaders and the specific communication channels.

According to one embodiment of the present invention, a computer program product defines marketing strategies by identifying social commerce patterns. The computer program product comprises a computer readable storage medium having computer readable program code embodied therewith. Computer readable program code is configured to build a social network relating consumers to a commerce system of interest. Computer readable program code is configured to assign weights for individual nodes of the social network based on predetermined criteria. Computer readable program code is configured to navigate the social network to identify customer leaders and define customer segments of the commerce system. Computer readable program code is configured to navigate the social network to identify specific communication channels relative to the customer leaders. Computer readable program code is configured to define marketing strategies using the customer leaders and the specific communication channels.

A computer system defines marketing strategies by identifying social commerce patterns. A processor is programmed to: build a social network relating consumers to a commerce system of interest, assign weights for individual nodes of the social network based on predetermined criteria, navigate the social network to identify customer leaders and define customer segments of the commerce system, navigate the social network to identify specific communication channels relative to the customer leaders, and define marketing strategies using the customer leaders and the specific communication channels.

### BRIEF DESCRIPTION OF THE SEVERAL VIEWS OF THE DRAWINGS

FIG. 1 is a typical computer system suitable for use with an embodiment of the present invention;

FIG. 2 is an illustration of an overview of an embodiment of the present invention;

FIG. 3 illustrates use of a blog;

FIG. 4 shows a sample social network formed by a blog;

FIG. 5 shows use of a table for assigning social weight points for use with an embodiment of the present invention; and

FIG. 6 illustrates navigating for a targeted conversion.

### DETAILED DESCRIPTION

As will be appreciated by one skilled in the art, aspects of the present invention may be embodied as a system, method or computer program product. Accordingly, aspects of the present invention may take the form of an entirely hardware embodiment or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

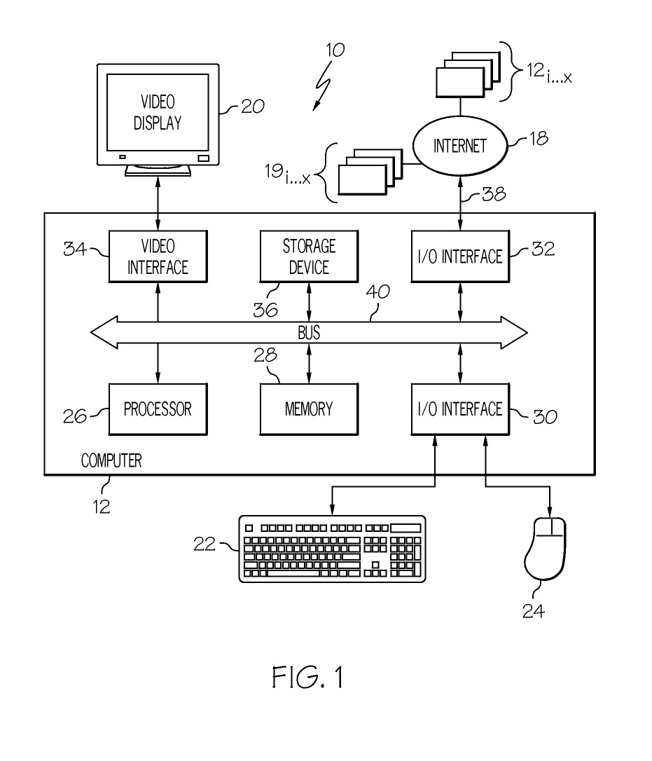

FIG. 1 is one example of a computer system 10 suitable for defining marketing strategies by identifying influential social commerce patterns in accordance with the techniques described. Other processing devices which are suitable for executing the software can be a wireless telephone, personal assistant device (PDA), portable computer, smart remote control device, or any other processing devices that can execute such software.

The computer system 10 is of a type that executes under a suitable operating system installed on the computer system 10, and may be thought of as comprising software code for defining marketing strategies by identifying influential social commerce patterns. The components of the computer system 10 include a computer 12, a keyboard 22, mouse 24, and a video display 20. The computer 12 includes a processor 26, a memory 28, input/output (I/O) interfaces 30 and 32, a video interface 34, and a storage device 36.

The processor 26 is a central processing unit (CPU) that executes the operating system and the computer software executing under the operating system. The memory 28 includes random access memory (RAM) and read-only memory (ROM), and is used under direction of the processor 26.

The video interface 34 is connected to a video display 20 and provides video signals for display thereon. User input to operate the computer 12 is provided from the keyboard 22 and mouse 24. The storage device 36 can include a disk drive or any other suitable storage medium, as discussed above. Each of the components of the computer 12 is connected to an internal bus 40 that includes data, address, and control buses, to allow components of the computer 12 to communicate with each other via the bus 40. The computer system 10 can be connected to one or more other similar computers 12_{i . . . x} via an input/output (I/O) interface 32 using a communication channel 38 to a network, represented as the Internet 18. One or more servers 19_{i . . . x} may be connected to the computer 12 via a network, such as, the Internet 18. The servers 19_{i . . . x} may comprise the same physical arrangement as the computer 12 and may be co-located with or a part of the computer 12.

The computer software may be recorded on a computer readable storage medium, in which case, the computer software program is accessed by the computer system 10 from the storage device 36. Alternatively, the computer software can be accessed directly from the Internet 18 by the computer 12. In either case, a user can interact with the computer system 10 using the keyboard 22 and mouse 24 to operate the programmed computer software executing on the computer 12.

In order to create a system that provides the most value from a marketing perspective, it is helpful to involve customers as product “ambassadors.” As used herein, the term ‘customer leaders’ will be used to represent these ambassadors within a social network that have definable leadership or influence over other members of a social network. However, customers, no matter how ‘good’ they are, will not always be willing to do something for nothing. Therefore, it is preferable to build a customer reward program into the system. As will be subsequently described in greater detail, one such program may include points for achieving certain actions. The points can accumulate and then be ‘spent’ by the customer in a predefined manner. Not only are customer leaders important, but any information about a commerce related activity that is popular among consumers is also important, as it can act as a valuable source for the online stores to reach out to consumers.

An embodiment of the present invention obtains social commerce patterns that indicate social influence by navigating. As used herein, navigating refers to crawling or mining through a network, such as a social network formed by consumers. Such patterns can be, for example, any of the following:
A person in a network who appears to be valued by others in the network.
A person who appears to be valued by others through a specific channel (mobile/web/social network/email etc.,).
A person who appears to be valued by others for a specific product/domain.
A person who appears to be valued by others in a social activity (like blogging/providing reviews etc.,).
A person who appears to be valued by others associated with a social activity.
An influential commerce activity (such as coupons).
A person who appears to be valued by others associated with an influential commerce activity.
An influential segment/domain in which individuals are influential.

A social commerce pattern, once extracted and stored in a repository, can be used for defining better marketing strategies. For instance, a customer leader can be used as a brand ambassador, a social activity can be used to target advertisements, and a commerce activity can be used to market a product to bring in more revenue.

An embodiment of the present invention utilizes five steps, which will be subsequently described in greater detail, to obtain social commerce patterns of interest. Briefly, the five steps are:

1) Build a social web/network of consumers, using a processor, such as the processor 26, using social activities either by induced commerce transactions (coupon distribution) or utilizing existing social networks;

2) Once the network is formed and stored in a memory, such as the storage device 36, weights are assigned by the processor for individual nodes based on the popularity of the event associated with the node/generation of revenue by that node through various methods;

3) Navigate, under instructions from the processor, such as the processor 26, the associations to identify customer leaders, based upon a predetermined criteria, and define effective customer segments;

4) Navigate, under instructions from the processor, such as the processor 26, the social web for customer leaders, based upon a predetermined criteria, associated with a specific communication channel (such as mobile, web or social network) by which they are effective; and

5) The output obtained in steps 1-4 is used to define marketing strategies.

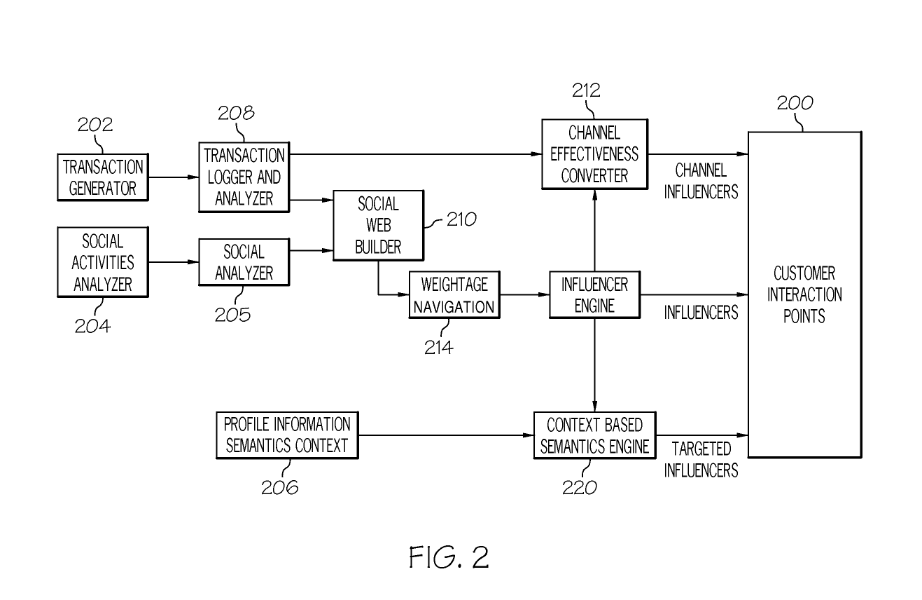

With reference to FIG. 2, an overview of one embodiment of the present invention further illustrates these five steps. Step 1 is shown as Social Web Builder 210. A social web from which desirable social commerce patterns can be obtained is not readily available. In accordance with one embodiment of the present invention, two different input sources are used to create this social web. A social web is a network and uses the term node to refer to objects in the network and links among nodes to represent the relationship between them. A commerce system refers to the entire online system comprising the stores, consumers, sales force, inventory force, consumer facing activities, such as, blog posting, review postings, and etc.

Source 1: Define marketing rules that dynamically generate the customer network. Source 1 is performed by inducing an electronic transaction over a network, such as the Internet, and capturing the path of the transaction. For example, an electronic coupon can be sent to individuals over the network, and the path the coupon takes over the network can be tracked to form the customer network/social web. One instance of a social web is where the nodes of the network represent the consumers and a relationship between two individuals is used as a link. Examples are given below to illustrate how transactions can be induced to generate such a network.

### Example 1

Commerce systems can generate electronic coupons having serial numbers as Id's. These coupons can target (typically performed by a component called a promotion engine) individuals, such as previous customers who have agreed to receive on-line materials, for example, a coupon informing consumers of a 50% reduction in price. The coupon can be forwarded by one individual to another until, finally, one of the consumers finds the coupon interesting and returns to the store to redeem it. The path taken by the coupon through the network from one individual to another can be utilized to generate the customer network/social web. The path the coupon travels can be tracked utilizing the serial id present on the coupon.

### Example 2

Buy 5 T-Shirts and obtain a 20% discount. An individual can seek out friends who might need a T-Shirt and gathers a group of 5 people who will be willing to combine their purchases. One coupon and/or one consumer, thus, providing a list of 5 different people as contacts.

Another instance of a social web is where the nodes of the network represent blog entries and a relationship between two blogs is used as a link. A blog is a type of website (or part of a website) in which individuals write articles related to specific topics and others can provide comment or reviews of the article. Transactions can be induced to generate such a network. Examples are given below to illustrate how transactions can be induced to generate a network.

### Example 1

An offer such as: Write 5 blog entries and obtain a 50% reduction on any merchandise. A consumer can create 5 entries or invite 5 other people to create entries. Such activities can be tracked and recorded to create a social web.

### Example 2

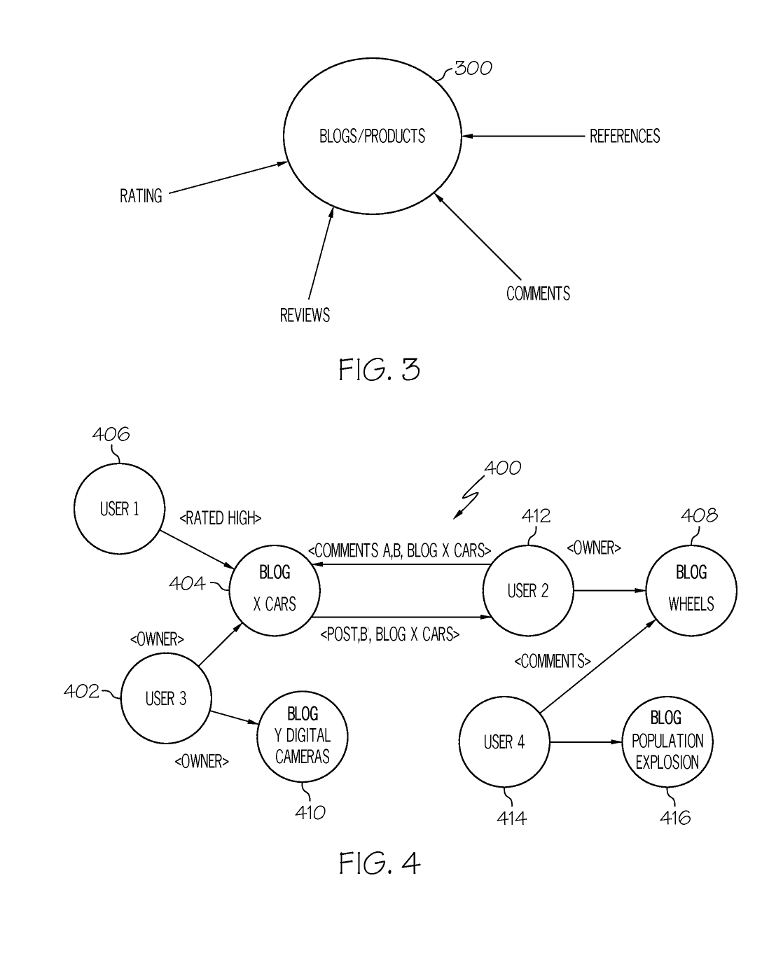

Mine existing product related blogs and product related reviews to generate this network. Typically a commerce system provides provisions to view all blogs and reviews for a specific product. FIG. 3 illustrates that blogs can be used as first class entities for defining a node and its relationship. A first class entity in a network of relationships refers to those entities that have the primary information and other information in the network is derived from this entity. A generic structure of a blog 300 is also presented. Blogs define two way communication over the Internet (a topic is posted and individuals can comment and counter comment on that topic), they allow assessment of the products through opinions expressed by users of the blog.

Referring to FIG. 4, a sample network 400 formed by a blog and its relationships in a real world example is illustrated. A User 3 (represented by a reference numeral 402) is the owner of a blog 404 named X Cars and another blog 410 named Y Digital Cameras. User 1 (represented by a reference numeral 406) reads the blog 404 and gives it a high rating. A user 2 (represented by a reference numeral 412) is the owner of a blog 408 named Wheels. User 2 (412) also reads and comments on blog 404. Finally, User 4 (represented by a reference numeral 414) is the owner of another blog 416 named Population Explosion. It can be seen that User 4 (414) also comments on the blog 408. A social web thus formed can also provide information on the different customer leaders in the network, whereas, a social web formed by a blog can provide information such as brand ambassadors, who are more influential in a domain (automobile domain, apparel domain etc.).

Source 2: Not only can a social web be developed using the customer and his activities related to commerce in the network but also by utilizing the existing social networks which are available in the social networking sites.

By integrating social graphs from social networking sites, it is possible to determine who has a wide network of friends and acquaintances. This can be accomplished by looking at their link relationships (friends, best friends etc.), and who has a high activity rating (such as, many message exchanges).

An existing social network available on the Internet can be easily imported into a commerce store. There can be specific adaptors in commerce systems that allow the social network from the external world to be imported to the commerce system. Once imported a filter should be used to obtain a map of the consumers in the commerce system on this social network. For example: A person “USER X” has a facebook and orkut account. His facebook and orkut set of friends and their friends form a social network. He is also a member of a movie multiplex called “FutureMovies.” FutureMovies uses a commerce system to sell tickets and provide updated movie information to people. For “FutureMovies” commerce system, USER X's facebook and orkut social networks are external and have to be imported. The social network of USER X from facebook and orkut might contain members who are already part of “FutureMovies.” A filter can used to obtain such members and form a social web for the merchant.

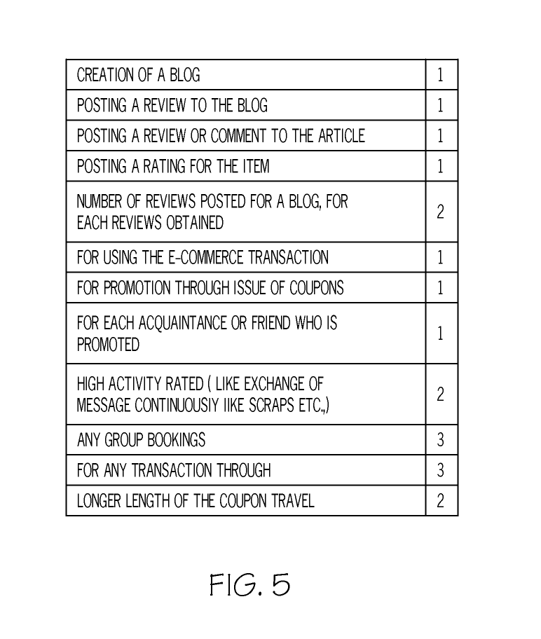

Referring again to FIG. 2, Step 2 of one embodiment of the present invention is shown at Weightage Navigation 214. Once the network is formed weights can be assigned for individual nodes. By assigning weights it is possible to provide a relative reference, and, therefore, to identify the most influential nodes (a person is represented by a node). A weight table as shown in FIG. 5 provides an example of different weights that may be assigned to nodes based on the activities individuals may perform on a commerce site. Weights are calculated based on the importance of the activity (in-terms of revenue generation) to the commerce system.

As can be seen in FIG. 5, “Creation of a blog,” “Posting a review to the blog,” “Posting a review or comment to the article,” “Posting a rating for the item,” “For using the e-commerce transaction,” “For promotion, through issue of coupons,” and “For each acquaintance or friend who is promoted” all receive a weightage of one. Similarly, other actions considered to be of more value may receive higher weights, such as, a weight of two for a “Longer length of the coupon travel” and a weight of three for “Any group bookings.” Obviously, other factors may be included, and the weights modified as deemed appropriate for the situation.

Referring back to FIG. 2, Step 3 of one embodiment of the present invention is shown as Context based Semantics Engine 220. It is desirable to find who is influential in specific target segments. For instance, a person might be influential in the domain of children's apparel. In order to determine this, profile information on a person in context is used, such as, in which store he bought targeted products. Other possibilities could then be mapped to having kids. Surveys can also be targeted to specific individuals. The outcome of this step is that individuals who may be customer leaders are associated with segment/domain in which they are influential.

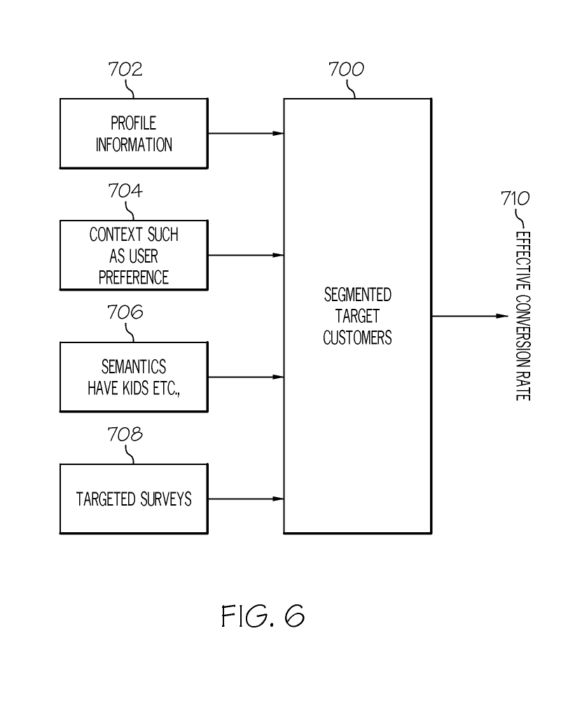

Referring to FIG. 6, navigating for a targeted conversion in accordance with step 3 is further illustrated. The nodes in the graph (FIG. 4) can be sorted in a descending order of weight. The higher the weight the higher is the influence of the entity (a person or a blog depending on the network). Profile information 702, as well as information from consumer external social communities can be utilized to classify the segments. For example, a promotion for children's clothing can be targeted to customers identified to have children 706; movies can be targeted to people based on their preferences 704, such as thrillers; surveys 708 can be sent to identified and targeted individuals; and etc. Thus, correctly segmented target customers 700 will result in a more effective sale conversion rate 710.

The fourth step is indicated in FIG. 2 as Channel Effectiveness Converter 212. It is as important to track the effectiveness of the channel used to conduct a commercial transaction as it is to determine the transaction targets. Thus, a system to track the effectiveness of the channel is provided. A transaction may be tracked from the outgoing channel (mobile, web, in-store, kiosk, call-center, etc) and the convergence of the transaction through the incoming channel. The effectiveness can be measured by the outgoing channel, as it has resulted in a completed transaction.

The fifth step is indicated in FIG. 2 as Customer Interaction Points (CIP) 200. Step 5 indicates that the output gained from steps 1-4 is used with customer interaction points in a commerce work flow. Thus, an already determined customer leader can log into a store web site and receive a coupon directed at his/her known product interests.

CIP 200 will provide the merchant with customer contact points wherein effective marketing strategies can be used. For example, when a person buys a ticket for a movie, an offer can be introduced saying that if he enters a review for the movie after watching, he can get 20% off the movie ticket price. The CIP here is “Where the customer buys the ticket.” There are three parallel systems of information that provide input to CIP 200. These are the transaction generator 202, the social activities analyzer 204, and the profile information semantics context 206.

The transaction generator 202 generates induced transactions. A transaction logger and analyzer 208 maintain a history of the actions of the transaction generator 202. In addition, the transactions are analyzed to determine the statistics that are of interest to the merchant, such as, how many purchases customer X made. Information from the logger and analyzer 208 is provided to the social web builder 210 and the channel effectiveness converter 212 for use as described above. The Social Activities analyzer 204 and the Social Analyzer 205 provide input to the Social Web builder 210.

The corresponding structures, materials, acts, and equivalents of all elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A method for defining marketing strategies by identifying social commerce patterns, comprising:
building a social network relating consumers to a commerce system of interest;
assigning weights for individual nodes of said social network based on predetermined criteria, said weights and said criteria being stored in a memory;
navigating said social network, under instruction of a microprocessor, to identify customer leaders based on said stored weights and to define customer segments of the commerce system;
navigating said social network, under instruction of said microprocessor, to identify specific communication channels relative to said customer leaders;
storing said identified customer leaders and said identified specific communication channels in said memory; and
defining, with said microprocessor, marketing strategies using said stored customer leaders and said stored specific communication channels.

2. The method of claim 1, wherein the social network is built using induced commerce transactions.

3. The method of claim 1, wherein the social network is built by integrating social graphs from existing social networks.

4. The method of claim 1, wherein said predetermined criteria include activities that result in completed commerce transactions.

5. The method of claim 1, wherein said predetermined criteria include how many communications there are between said customer leaders and other consumers.

6. The method of claim 1, wherein social activities related to commerce are tracked for commerce value.

7. The method of claim 6, wherein identifying said social activities comprises monitoring communications for said social activities.

8. The method of claim 1, wherein said customer leaders are provided with incentive points for engaging in social activities, wherein said social activities are ranked in accordance with a predetermined commerce value.

9. The method of claim 1, wherein key interaction points of the customer with the stores are defined and used to market to consumers.

10. A computer program product for defining marketing strategies by identifying social commerce patterns, the computer program product comprising a computer readable storage medium having computer readable program code embodied therewith, the computer readable program code comprising:
computer readable program code configured to build a social network relating consumers to a commerce system of interest;
computer readable program code configured to assign weights for individual nodes of said social network based on predetermined criteria;
computer readable program code configured to navigate said social network to identify customer leaders based on said weights and to define customer segments of said commerce system;
computer readable program code configured to navigate said social network to identify specific communication channels relative to said customer leaders; and
computer readable program code configured to define marketing strategies using said customer leaders and said specific communication channels.

11. The computer program product of claim 10, further comprising computer readable program code configured to build said social network using induced commerce transactions.

12. The computer program product of claim 10, further comprising computer readable program code configured to build said social network by integrating social graphs from existing social networks/social networking sites.

13. The computer program product claim 10, wherein said predetermined criteria include activities that result in completed commerce transactions.

14. The computer program product of claim 10, wherein said predetermined criteria include how many communications there are between said customer leaders and other consumers.

15. The computer program product of claim 10, further comprising computer readable program code configured to track social activities related to commerce.

16. The computer program product of claim 15, further comprising computer readable program code configured to identify said social activities by monitoring communications for said social activities.

17. The computer program product of claim 10, further comprising computer readable program code configured to provide said customer leaders with incentive points for engaging in social activities, wherein said social activities are ranked in accordance with a predetermined commerce value.

18. The computer program product of claim 10, wherein key customer interaction points are defined and used to market to consumers.

19. A computer system for defining marketing strategies by identifying social commerce patterns, comprising:
a processor programmed to:
build a social network relating consumers to a commerce system of interest;
assign weights for individual nodes of said social network based on predetermined criteria;
navigate said social network to identify customer leaders and define customer segments of said commerce system;
navigate said social network to identify specific communication channels relative to said customer leaders; and
define effective marketing strategies using said customer leaders and said specific communication channels.

20. The computer system of claim 19, wherein said processor is further programmed to build said social network using induced commerce transactions.

21. The computer system of claim 19, wherein said processor is further programmed to build said social network by integrating social graphs from pre-existing social networks.

22. The computer system of claim 19, wherein said predetermined criteria include activities that result in completed commerce transactions.

23. The computer system of claim 19, wherein said processor is further programmed to track social activities related to commerce.

24. The computer system of claim 19, wherein said processor is further programmed to provide said customer leaders with incentive points for engaging in social activities, wherein said social activities are ranked in accordance with a predetermined commerce value.

25. The computer system of claim 19, wherein key customer interaction points are defined and used to market to consumers.
